(19) United States
(12) Patent Application Publication
(10) Pub. No.: US 2002/0169677 A1
(43) Pub. Date: Nov. 14, 2002

(54) Systems and methods wherein a consuming device receives an executable consumption program

(76) Inventors: Barry E. Willner, Briarcliff Manor, NY (US); Edith H. Stern, Yorktown Heights, NY (US); Paul A. Moskowitz, Yorktown Heights, NY (US); Philip S. Yu, Chappaqua, NY (US); David P. Greene, Ossining, NY (US); William Grey, Millwood, NY (US)

Correspondence Address: BUCKLEY, MASCHOFF, TALWALKAR, & ALLISON, 5 ELM STREET, NEW CANAAN, CT, 06840, US

(21) Appl. No.: 09/804,634

(22) Filed: Feb. 21, 2001

(51) Int. Cl. G06F 17/60

(52) U.S. Cl. 705/26

(57) ABSTRACT

Systems and methods are provided wherein a consuming device receives an executable consumption program. According to one embodiment, a consuming device transmits a request for the executable consumption program to a consumable item or to a device associated with a consumable item. The consumable item or the device associated with the consumable item then transmits the executable consumption program to the consuming item. For example, a fuel pump may transmit an updated fuel injection software program to an automobile. According to another embodiment, a consuming device receives a supplemental consumable item in response to execution of the executable consumption program.

### FIELD

The present invention relates to consumption systems. In particular, the present invention relates to systems and methods wherein a consuming device receives an executable consumption program.

### BACKGROUND

Many devices use consumable items during operation. For example, some devices are powered by consumable items, such as automobiles which are powered by gasoline and laptop computers which are powered by one or more batteries. Other devices transform consumable items, such as printers that print on paper and entertainment devices that output entertainment based on electronically represented information (e.g., an electronic representation of a book, a song, or a movie).

Moreover, many devices that use consumable items (i.e., “consuming devices”) include, or are associated with, processors that are adapted to execute software programs. For example, an automobile may include an Electronic Control Unit (ECU) device that executes a software program. Such an ECU device may control, for example, an emissions system or transmission system associated with the automobile. Note that a single automobile may include a number of different ECU devices. Other consuming devices may similarly be associated with processors, such as a processor that formats information for a printer or a processor that translates information for an entertainment device.

However, a software program written for such a processor may not enable the consuming device to perform efficiently and effectively. For example, a manufacturer may sell a number of consuming devices before discovering a problem with a software program that prevents the consuming devices from using consumable items efficiently. Even if the manufacturer releases an updated version of the software program to address the problem, there may not be a practical way to distribute the updated version to the consuming devices that have already been sold.

Moreover, a number of factors can reduce how efficiently and/or effectively a consuming device will use a consumable item. For example, a consuming device may include a processor that executes a software program adapted to use a particular type of consumable item. In this case, replacing that particular type of consumable item with a new type of consumable item may cause the consuming device to operate less efficiently and/or effectively.

Consider an automobile with a fuel injection software program that is adapted to burn a particular type of gasoline. If a governmental authority then mandates the use of a new fuel additive to reduce emissions, the efficiency of the fuel injection system may be reduced. Note that it may be impractical to have an operator of the automobile attempt to retrieve and install an updated version of the fuel injection software program. It also may be impractical to equip all automobiles with communication devices to enable an automatic installation of an updated version.

### SUMMARY

To alleviate problems inherent in the prior art, the present invention introduces systems and methods wherein a consuming device receives an executable consumption program.

According to one embodiment of the present invention, a request for an executable consumption program is received. The request is received from a device associated with a consumption of a consumable item, and it is arranged for the device to receive the executable consumption program.

According to another embodiment, an executable consumption program request is transmitted to a device associated with a consumable item, and the executable consumption program is received.

According to still another embodiment, a consumable item is received along with an executable consumption program. The executable consumption program is executed, and a supplemental consumable item is received.

Another embodiment is directed to a consumable item having a consumable portion and an executable consumption program. The executable consumption program is associated with the exchange of a supplemental consumable item.

One embodiment of the present invention comprises: means for receiving a request for an executable consumption program, the request being received from a device associated with a consumption of a consumable item; and means for arranging for the device to receive the executable consumption program.

Another embodiment comprises: means for receiving a consumable item along with an executable consumption program; means for executing the executable consumption program; and means for receiving a supplemental consumable item in response to the execution.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is an information flow diagram according to an embodiment of the present invention.

FIG. 2 is a flow chart of a method according to an embodiment of the present invention.

FIG. 3 is a block diagram overview of a consumption system according to an embodiment of the present invention.

FIG. 4 is a block diagram overview of a fuel dispensing system according to an embodiment of the present invention.

FIG. 5 is an information flow diagram according to another embodiment of the present invention.

FIG. 6 is a flow chart of a method according to another embodiment of the present invention.

FIG. 7 is a block diagram of a dispensing device according to an embodiment of the present invention.

FIG. 8 is a block diagram of a consuming device according to an embodiment of the present invention.

FIG. 9 is a tabular representation of a portion of an executable consumption program database according to an embodiment of the present invention.

FIG. 10 is a tabular representation of a portion of an executable consumption program rule database according to an embodiment of the present invention.

FIG. 11 is a tabular representation of a record in a transaction database according to an embodiment of the present invention.

FIG. 12 is a tabular representation of a portion of a consuming device output parameter database according to an embodiment of the present invention.

### DETAILED DESCRIPTION

Embodiments of the present invention are directed to systems and methods wherein a “consuming device” receives an executable consumption program. As used herein, the phrase “consuming device” refers to any device capable of using a consumable item. For example, a consuming device may be device that is powered by a fuel, such as a vehicle. Examples of fuels include gasoline, propane, and electricity (including batteries used to power a portable device). A consuming device may also be a device that transforms a consumable item, such as a printer that transforms paper or a cooking device that transforms a food ingredient. A consuming device may also be a device that utilizes a consumable item, such as a communication device that utilizes bandwidth to communicate electronic information. A consuming device may also be a device adapted to translate or output a consumable item, such as a Compact Disc (CD) player or other entertainment device adapted to provide entertainment information (e.g., by “consuming” an electronic representation of a book, a song, or a movie) to a consumer.

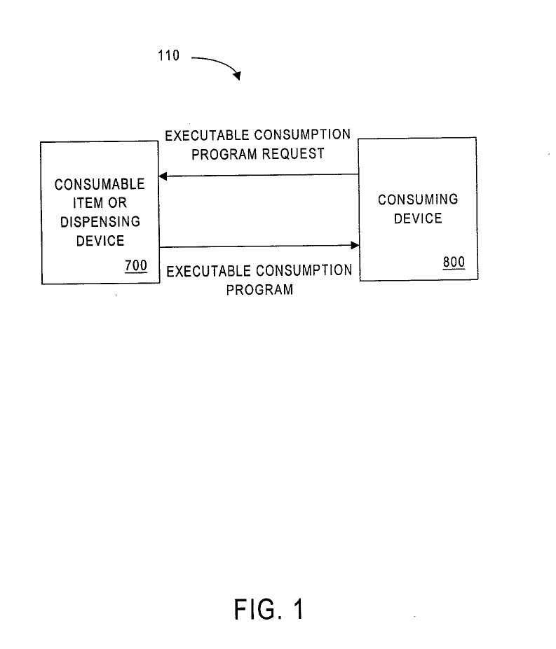

Turning now in detail to the drawings, FIG. 1 is an information flow diagram according to one embodiment of the present invention. As shown in FIG. 1, a consumption system 110 may comprise a consumable item 700 communicating with a consuming device 800. The consumable item 700 may comprise, for example, fuel, bandwidth, entertainment information, executable information, food, and/or information storage capacity.

Note that the consuming device 800 may instead communicate with, for example, a consumable item dispensing device (e.g., a fuel pump) or a controller associated with the consumable item 700. The consumable item or dispensing device 700 may also comprise, for example, a package containing the consumable item, a medium storing the consumable item, a device attached to the consumable item, a device incorporated within the consumable item, and/or a device located in proximity with the consumable item.

The consuming device 800 may comprise, for example, a device adapted to control a consumption of the consumable item, a device that consumes the item, a device powered by the consumable item, a vehicle, a device adapted to transform the consumable item, a medium for storing the consumable item, and/or a processor for executing or translating the consumable item.

According to an embodiment of the present invention, the consuming device 800 transmits an executable consumption program request to the consumable item or dispensing device 700. For example, an automobile may transmit such a request to a fuel pump. The request may include, for example, a requesting device identifier (e.g., a vehicle identification number), a customer identifier, a consumable item provider identifier, a third party identifier, a requested executable consumption program identifier, a current executable consumption program identifier, a payment identifier, and/or a consumable item identifier.

The consumable item or dispensing device 700 then transmits an executable consumption program to the consuming device 800. According to one embodiment, the executable consumption program is adapted to improve a consumption of the consumable item. For example, a fuel pump may transmit an updated version of a fuel injection software program to an automobile.

The consuming device 800 then consumes the consumable item 700 and/or executes the executable consumption program. According to one embodiment, the consuming device 800 actually consumes the consumable item 700 in accordance with the executable consumption program.

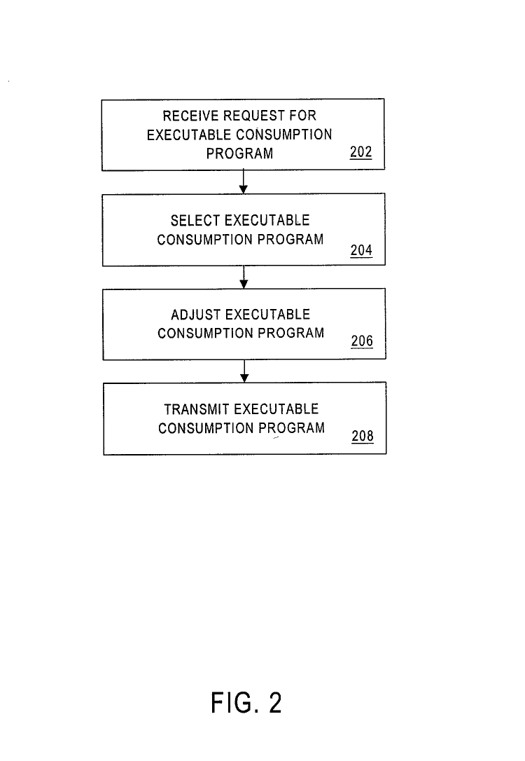

FIG. 2 is a flow chart of a method that may be performed according to this embodiment. The method may be performed, for example, by the consumable item or dispensing device 700 shown in FIG. 1. The flow charts in FIG. 2 and the other figures described herein do not imply a fixed order to the steps, and embodiments of the present invention can be practiced in any order that is practicable. Moreover, the method may instead be performed by any of the devices described herein.

At 202, a request for an executable consumption program is received. For example, a fuel pump may receive a request for an executable consumption program from an automobile via a Bluetooth communication.

At 204, an executable consumption program is selected. According to some embodiments of the present invention, the executable consumption may be selected based on information received from the consuming device, information associated with the consumable item, and/or an ambient condition. For example, the request for the executable consumption program may include information indicating an automobile model number. The fuel pump may then select an appropriate executable consumption program based on the automobile model number. According to one embodiment, the fuel pump may also retrieve the executable consumption program from a third party device, such as by retrieving the executable consumption program via the Internet.

The executable consumption program may also be adjusted at 206. According to some embodiments of the present invention, the executable consumption may be adjusted based on information received from the consuming device, information associated with the consumable item, and/or an ambient condition. For example, the fuel pump may modify portions of the executable consumption program based on a current air quality level in a particular region.

The executable consumption program is then transmitted to the consuming device at 208. For example, the fuel pump may transmit the executable consumption program to the automobile. According to one embodiment, a payment is received (e.g., from the driver or the automobile manufacturer) in exchange for the executable consumption program.

### Consumption System Overview

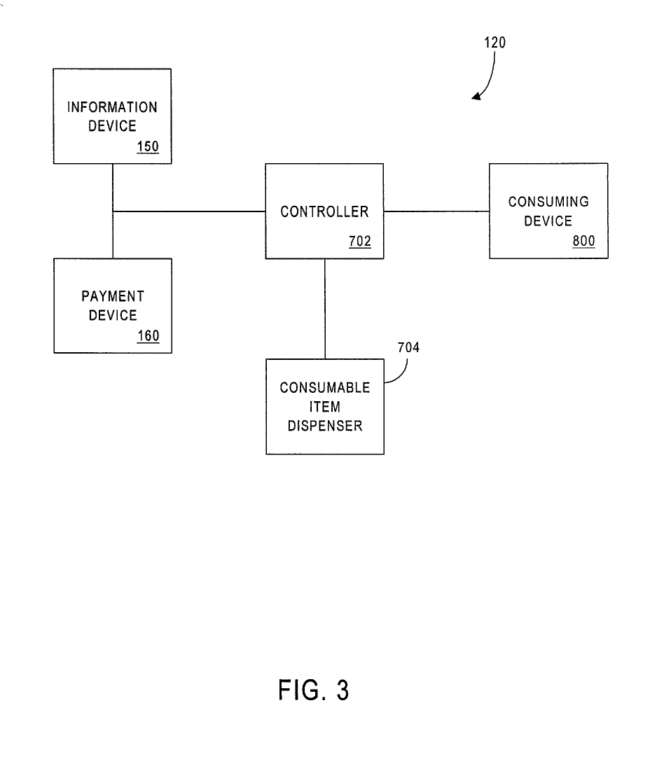

FIG. 3 is a block diagram of a consumption system 120 according to one embodiment of the present invention. The consumption system 120 includes a controller 702 in communication with a consuming device 800. As used herein, devices (such as the consuming device 800 and the controller 702) may communicate via a direct connection, such as a Universal Serial Bus (USB) connection. Devices may also communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN network (e.g., in accordance with an 802.11 standard), or an Internet Protocol (IP) network such as the Internet, an intranet or an extranet. Devices may further communicate through chemicals or materials. For example, a device may be adapted to detect whether or not a particular chemical is present in a consumable item.

Note that, as used herein, communications include those enabled by wired or wireless technology. For example, the controller 702 may communicate with the consuming device 800 using Bluetooth technology. Bluetooth technology allows a wide range of computing and telecommunication devices to be interconnected via wireless connections. Specifications and other information regarding Bluetooth technology are available at the Bluetooth Web site www.bluetooth.com. In embodiments utilizing Bluetooth technology, communicating devices may be equipped with a microchip transceiver that transmits and receives information in a frequency band of 2.45 GHz (with some variation of bandwidth in different countries). Connections can be point-to-point or multipoint over a current maximum range of ten meters. Embodiments using Bluetooth technology may require the additional use of one or more communication stations (e.g., a communication station may be positioned near a fuel dispensing device, and the communication station may relay information between the controller 702 and the consuming device 800).

Note that although a single controller 702 is shown in FIG. 3, any number of controllers 702 may be included in the consumption system 120. Similarly, any number of consuming devices 800, or other devices described herein, may be included in the consumption system 120 according to embodiments of the present invention.

The consuming device 800 and the controller 702 may be any devices capable of performing the various functions described herein. The consuming device 800 may be, for example: a PC, a portable computing device such as a Personal Digital Assistant (PDA), a wired or wireless telephone, a game terminal (e.g., a SONY PLAY STATION® video game terminal), a CD player, a printer, an automobile or a processor associated with an automobile, or any other appropriate storage and/or communication device.

The controller 702 is also in communication with a consumable item dispenser 704. According to one embodiment, the controller 702 and the consumable item dispenser 704 are incorporated into a single device, such as a gasoline pump. According to one embodiment, the controller 702 also communicates with an information device 150. For example, controllers 702 located at a number of different gasoline stations may receive executable consumption programs (e.g., fuel injection software programs) or rules from one or more remote information devices 150 via the Internet.

Note that the devices shown in FIG. 3 need not be in constant communication. For example, the controller 702 may communicate with the information device 150 on an as-needed or periodic basis. Similarly, the controller 702 may communicate with a consuming device 800 only when the consuming device 800 is located near the controller 702 or the consumable item dispenser 704.

According one embodiment of the present invention, the controller 702 receives a request for an executable consumption program from the consuming device 800 (e.g., from an automobile). The controller 702 then arranges for an appropriate executable consumption program to be transmitted to the consuming device 800. Note that, according to one embodiment, the consuming device 800 does not need to send a request for the executable consumption program to the controller 702.

The controller 702 and/or the consuming device 800 may further arrange for an exchange of payment associated with a customer, a provider (e.g., a provider of the consumable item), and/or a third party. For example, the controller 702 may communicate with the payment device 160 to arrange for the customer to provide payment (e.g., via his or her credit card account, debit card account, banking account, or a digital payment protocol) based on an exchange of an executable consumption program and/or a consumable item. The controller 702 may also adjust a price associated with either the executable consumption program or a consumable item.

Note that payments may be exchanged with a third party (e.g., an automobile manufacturer associated with the information device 150) and that the consuming device 800 may communicate directly with the payment device 160. According to one embodiment, the controller 702 further verifies that the consuming device 800 is authorized to receive an executable consumption program. For example, only customers who subscribe to a supplemental service may be allowed to receive executable consumption programs.

Moreover, the controller 702 may transmit executable consumption programs to a plurality of consuming devices 800 (associated with a single customer or a plurality of customers) at substantially the same time.

### EXAMPLE

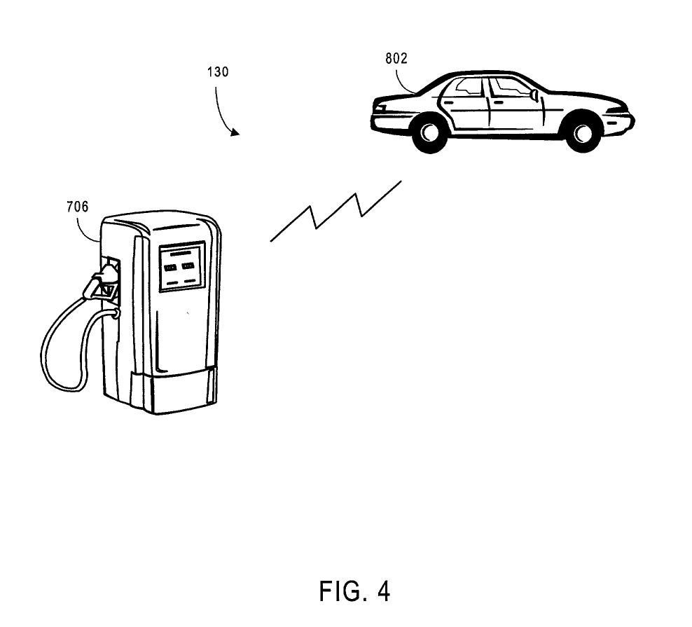

FIG. 4 is a block diagram overview of a fuel dispensing system 130 according to an embodiment of the present invention. As shown in FIG. 4, a fuel pump 706 (which may include, or communicate with, the controller 702 described with respect to FIG. 3) may communicate with an automobile 802.

When a customer drives his or her automobile 802 near the fuel pump 706, the fuel pump receives a request for an executable consumption program from the automobile 802. The request includes (i) the automobile's manufacturer, model number, and year of manufacture along with (ii) a list of executable software program versions currently stored in the automobile 802. Based on this information, the fuel pump 706 determines that the automobile 802 requires a software patch to enable the automobile 802 to more safely determine when an air-bag system should be activated. The fuel pump 706 then transmits the appropriate software patch to the automobile 802. According to another embodiment, a customer may also supply preference information (e.g., “I am willing to accept a 10% decrease in fuel efficiency in exchange for improved performance”) that may be used to select or adjust an executable consumption program.

As another example, consider a CD that stores both (i) an electronic representation of music and (ii) an executable consumption program. In this case, a CD player may retrieve the executable consumption program from the CD. The executable consumption program may, for example, include an updated version of a DOLBY® noise reduction software program used by the CD player.

### Supplemental Information Embodiment

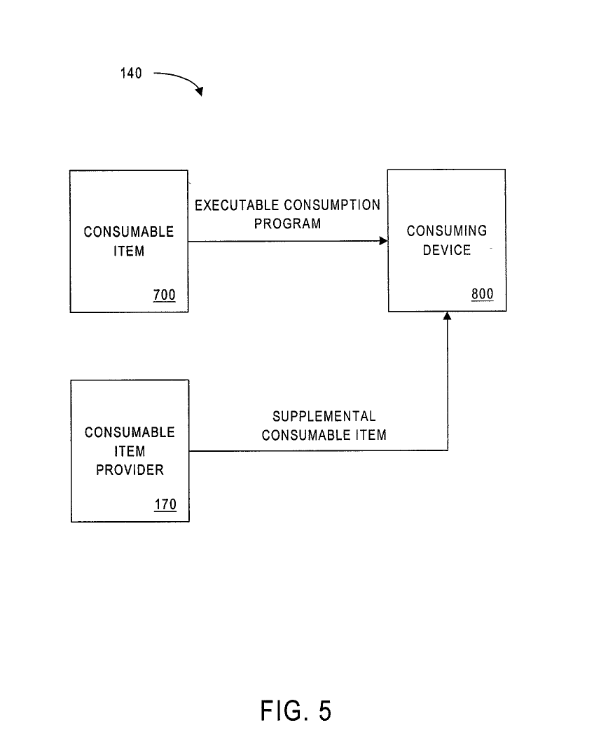

FIG. 5 is an information flow diagram according to another embodiment of the present invention. According to this embodiment, a consuming device 800 receives an executable consumption program in association with a consumable item 700. For example, a CD player may receive a CD that stores both (i) an electronic representation of music and (ii) an executable consumption program.

The consuming device 800 then executes the executable consumption program to retrieve a supplemental consumable item from a consumable item provider 170. For example, a processor in the CD player may execute the executable consumption program included on the CD to retrieve and decrypt an additional song via a communication network. Note that the supplemental consumable item may or may not be related to the original consumable item. For example, the executable consumption program may comprise a NAPSTER® type program that allows a user to select a supplemental consumable item.

According to one embodiment, the CD originally stores only an executable consumption program (e.g., and not an electronic representation of music). In this case, the CD itself is a “storage device” that is consumed by a CD player/recorder. For example, the CD player/recorder may execute the executable consumption program, retrieve an electronic representation of music (i.e., the “supplemental consumable item”) via the Internet, and record the electronic representation of music onto the CD. Thus, a manufacturer may package and distribute such a CD before the music has even been written (so long as the music is available when a customer places the CD into his or her CD player/recorder). Note also that, in this case, the consumable item and the supplemental consumable item are different types of items (e.g., a storage device and entertainment information).

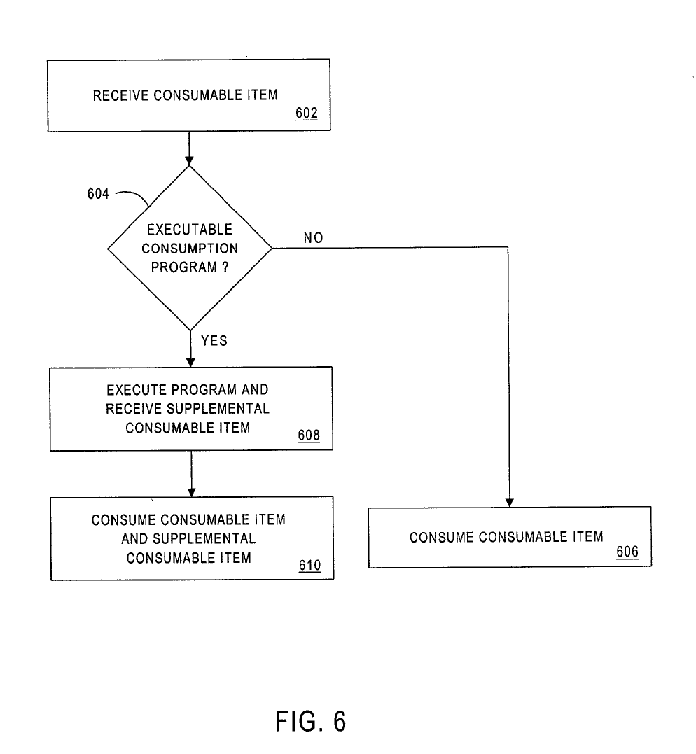

FIG. 6 is a flow chart of a method that may be performed according to this embodiment. At 602, a consumable item is received by a consuming device. If no executable consumption program is present at 604, the consumable item is consumed at 606.

If an executable consumption program is present at 604, the program is executed and a supplemental consumable item is received at 608. The supplemental consumable item may comprise for example, text information (e.g, the last chapter of a book), audio information, AND/or image information. The supplemental consumable item may instead comprise, for example, another executable program, such as a video game or a portion of a video game. In general, the supplemental consumable item may comprise any of the consumable items discussed herein. The consuming device then consumes the consumable item and the supplemental consumable item at 610. According to one embodiment, the consumable item and the supplemental consumable item are the same type of item (e.g., an executable consumption program may automatically re-order a supply of a consumable item for a consuming device).

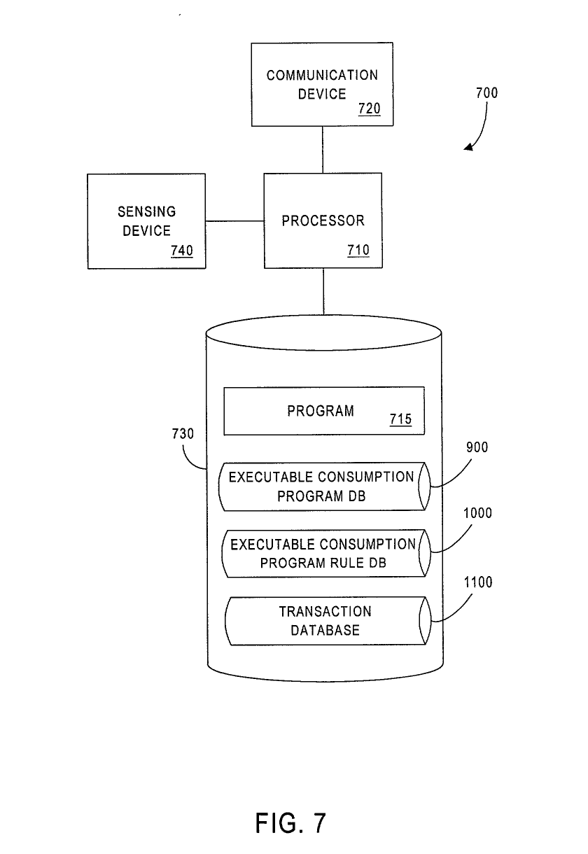

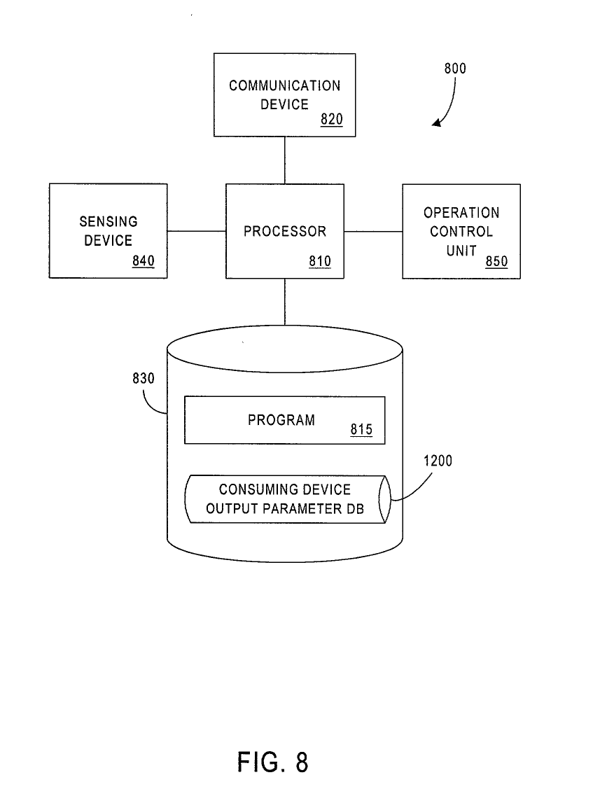

Examples of devices that may be used in connection with the systems 110, 120, 130, 140 discussed herein will now be described in detail with respect to FIGS. 7 and 8.

### Dispensing Device

FIG. 7 illustrates a dispensing device 700 that is descriptive of the device shown, for example, in FIG. 1 according to an embodiment of the present invention. The dispensing device 700 comprises a processor 710, such as one or more INTEL® Pentium® processors, coupled to a communication device 720 configured to communicate via a communication network (not shown in FIG. 7). The communication device 720 may be used to communicate, for example, with one or more consuming devices 800, information devices 150, and/or payment devices 160.

The processor 710 is also in communication with a sensing device 740. The sensing device 740 may comprise, for example, a thermometer. Such an sensing device 740 may be used, for example, to select or adjust an executable consumption program to be transmitted to a consuming device 800.

The processor 710 is also in communication with a storage device 730. The storage device 730 may comprise any appropriate information storage device, including combinations of magnetic storage devices (e.g., magnetic tape and hard disk drives), optical storage devices, and/or semiconductor memory devices such as RAM devices and Read Only Memory (ROM) devices.

The storage device 730 stores a program 715 for controlling the processor 710. The processor 710 performs instructions of the program 715, and thereby operates in accordance with the present invention. For example, the processor 710 may receive an executable consumption program request from a device associated with a consumable item. The processor 710 may also transmit the executable consumption program to the device.

As used herein, information may be “received” by or “transmitted” to, for example: (i) the dispensing device 700 from the consuming device 800; or (ii) a software application or module within the dispensing device 700 from another software application, module, or any other source.

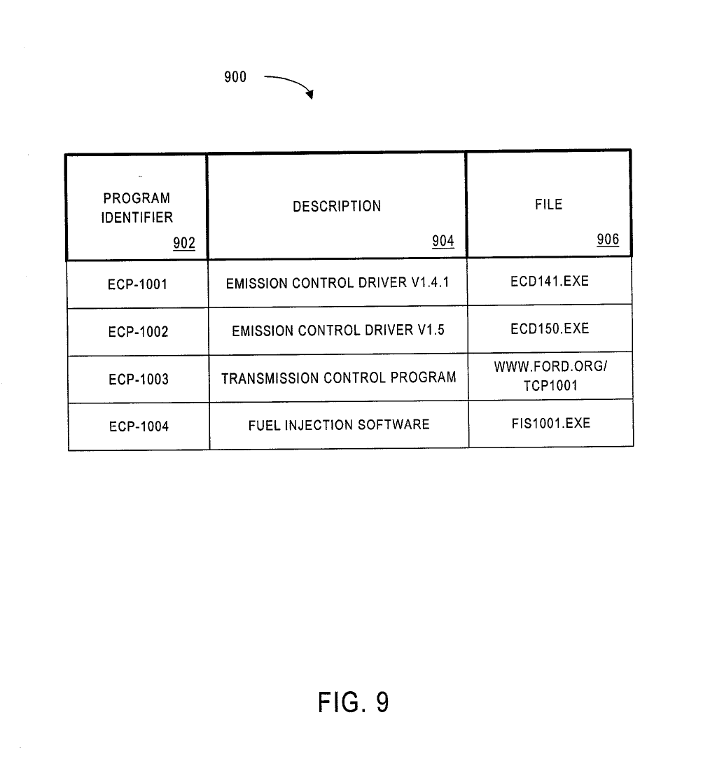

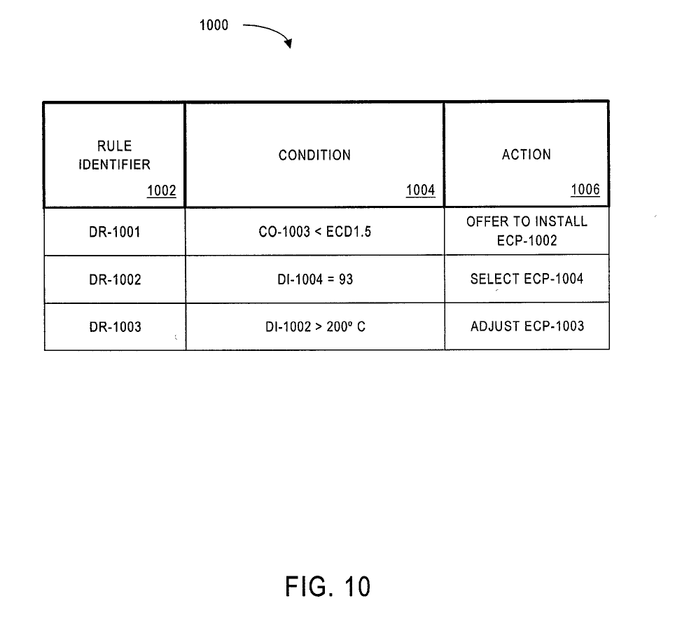

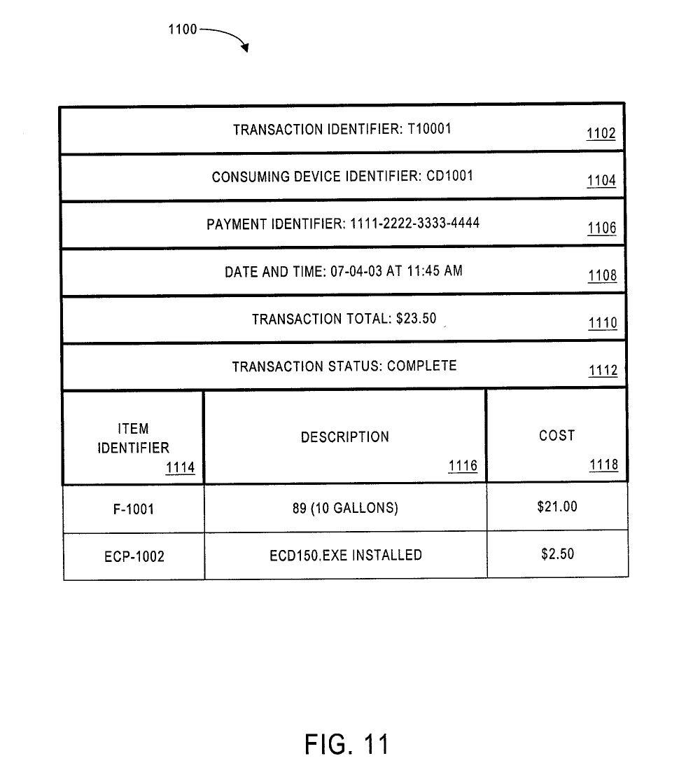

As shown in FIG. 7, the storage device 730 also stores: an executable consumption program database 900 (described with respect to FIG. 9); an executable consumption program rule database 1000 (described with respect to FIG. 10); and a transaction database 1100 (described with respect to FIG. 11).

### Consuming Device

FIG. 8 illustrates a consuming device 800 that is descriptive of the device shown, for example, in FIGS. 1, 3 and 5 according to some embodiments of the present invention. The consuming device 800 comprises a processor 810, such as one or more INTEL® Pentium® processors, coupled to a communication device 820 configured to communicate via a communication network (not shown in FIG. 8). The communication device 820 may be used to communicate, for example, with one or more dispensing devices 700, payment devices 160, and/or a consumable item provider 170.

The processor 810 is also in communication with a sensing device 840. The sensing device 840 may comprise, for example, a thermometer. Such an sensing device 840 may be used, for example, to determine one or more parameters to be transmitted to a dispensing device 700 along with an executable consumption program request.

The processor 810 is also in communication with an operation control unit 850. The operation control unit 850 may be used, for example, to control the consumption of a consumable item in accordance with an executable consumption program received from a dispensing device 700. The operation control unit 850 may comprise, for example, a processor that controls a fuel injection system in an automobile.

The processor 810 is also in communication with a storage device 830. The storage device 830 may comprise any appropriate information storage device, including combinations of magnetic storage devices (e.g., magnetic tape and hard disk drives), optical storage devices, and/or semiconductor memory devices such as RAM devices and ROM devices.

The storage device 830 stores a program 815 for controlling the processor 810. The processor 810 performs instructions of the program 815, and thereby operates in accordance with the present invention. For example, the processor 810 may transmit an executable consumption program request to a device associated with the consumable item (e.g., by transmitting the request to the dispensing device 700 via the communication device 820) and receive the executable consumption program. The processor 810 may also execute the executable consumption program.

According to another embodiment, the processor 810 executes an executable consumption program and, in response to the execution, receives a supplemental consumable item.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the consuming device 800 from the dispensing device 700; or (ii) a software application or module within the consuming device 800 from another software application, module, or any other source.

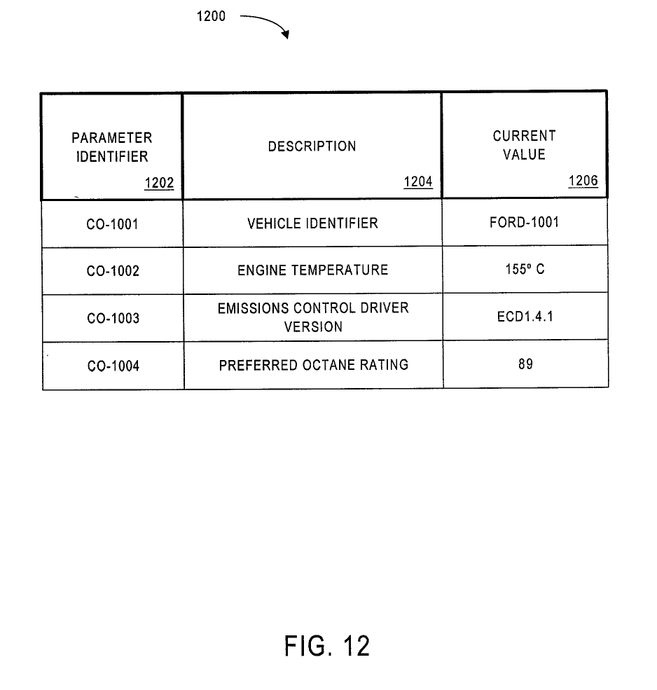

As shown in FIG. 8, the storage device 830 also stores a consuming device output parameter database 1200 (described with respect to FIG. 12). Examples of databases that may be used in connection with the systems 110, 120, 130, 140 will now be described in detail with respect to FIGS. 9 through 12. The illustrations and accompanying descriptions of the databases presented herein are exemplary, and any number of other database arrangements could be employed besides those suggested by the figures.

### Executable Consumption Program Database

Referring to FIG. 9, a table represents the executable consumption program database 900 that may be stored at the dispensing device 700 according to an embodiment of the present invention. The table includes entries identifying executable consumption programs that may be transmitted from the dispensing device 700 to a consuming device 800. The table also defines fields 902, 904, 906 for each of the entries. The fields specify: a program identifier 902, a description 904, and a file 906. The information in the executable consumption program database 900 may be created and updated, for example, based on information received from one or more information devices 150.

The program identifier 902 may be, for example, an alphanumeric code associated with executable consumption program that can be transmitted from the dispensing device 700 to the consuming device 800. The description 904 contains information describing the executable consumption program, and the file 906 may represent the program itself an indication of how the program may be accessed (e.g., via a communication network).

### Executable Consumption Program Rule Database

Referring to FIG. 10, a table represents the executable consumption program rule database 1000 that may be stored at the dispensing device 700 according to an embodiment of the present invention. The table includes entries identifying rules that may be used by the dispensing device 700 in association with one or more executable consumption programs. The table also defines fields 1002, 1004, 1006 for each of the entries. The fields specify: a rule identifier 1002, a condition 1004, and an action 1006.

The rule identifier 1002 may be, for example, an alphanumeric code associated with an executable consumption program rule. The condition 1004 indicates one or more conditions that may be evaluated by the dispensing device 700. The action 1006 indicates one or more acts or steps that may be performed by the dispensing device 700 when an associated condition 1004 is satisfied.

For example, as illustrated by the first entry shown in FIG. 10 (i.e., having a rule identifier 1002 of“DR-1001”), the dispensing device 700 may compare a parameter received from a consuming device 800 (i.e., “CO-1003” associated with the consuming device's emissions control driver version) with a threshold value. The dispensing device 700 may then perform an action 1006 based on the comparison. Note that the condition 1004 may instead be based on, for example, an ambient condition determined by the dispensing device 700 (e.g., via the sensing device 740).

### Transaction Database

Referring to FIG. 11, a table represents a record in the transaction database 1100 that may be stored at the dispensing device 700 according to an embodiment of the present invention. The database includes records associated with consumable item transactions. The information in the transaction database 1100 may be created and updated, for example, when a consumable item is purchased via the dispensing device 700.

As shown in FIG. 11, each record indicates a transaction identifier 1102 and a consuming device identifier 1104 associated with the transaction and a consuming device, respectively. Each record also includes a payment identifier 1106 associated with the transaction. The payment identifier 1106 may comprise, for example, a credit card, debit card or bank account number (e.g., a checking account number) or digital payment protocol information. The payment identifier 1106 may be used, for example, by the dispensing device 700 to arrange for a customer to provide payment in exchange for a consumable item and/or an executable consumption program. A date and time 1108 indicates a date and time associated with the transaction, and a transaction total 1110 indicates a total amount paid by the customer (e.g., in exchange for a consumable item). A transaction status 1112 indicates whether the transaction is “in process” or “complete.”

The table also defines fields 1114, 1116, 1118 for each record. The fields specify: an item identifier 1114, a description 1116, and a cost 1118. The item identifier 1114 may be based on, or associated with, the program identifier 902 stored in the executable consumption program database 900.

The description 1116 describes the item involved in the transaction (e.g., the consumable item or the executable consumption program). The description 1116 may indicate, for example, a software program version number or date. The cost 1118 indicates an amount paid by a customer in association with the item identifier 1114. Note that the transaction total 1110 may be calculated by adding each of the costs 1118 associated with the transaction.

### Consuming Device Output Parameter Database

Referring to FIG. 12, a table represents the consuming device output parameter database 1200 that may be stored at the consuming device 800 according to an embodiment of the present invention. The table includes entries identifying parameters that may be transmitted from the consuming device 800 to a dispensing device 700 (e.g., along with an executable consumption program request). The table also defines fields 1202, 1204, 1206 for each of the entries. The fields specify: a parameter identifier 1202, a description 1204, and a current value 1206. The information in the consuming device output parameter database 1200 may be created and updated, for example, based on information received from one or more sensing devices 840.

The parameter identifier 1202 may be, for example, an alphanumeric code associated with parameter that can be transmitted from the consuming device 800 to a dispensing device 700.

The description 1204 contains information describing the parameter, and the current value 1206 represent the value that is currently associated with the parameter. The current value 1206 may be, for example, transmitted to a dispensing device 700 which in turn may select or adjust an executable consumption program as appropriate.

### Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated with an executable consumption program being transmitted from a consumable item (or a device associated with a consumable item) to a consuming device, according to another embodiment the executable consumption program is instead transmitted from the consuming device to the consumable item (or the device associated with the consumable item). For example, a portable device may transmit instructions to a battery associated with a level of power that should be supplied by the battery.

Similarly, although some of the embodiments are described with respect to fuel being dispensed to an automobile, according to another embodiment the executable consumption program is exchanged in association with fuel being dispensed to an airplane or a boat. Similarly, according to other embodiments, fuel is instead dispensed from a fuel delivery service to a gasoline station or from an oil delivery service to a customer's home oil tank.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating consumption of a consumable item, comprising:
receiving a request for an executable consumption program, the request being received from a device associated with a consumption of the consumable item; and
arranging for the device to receive the executable consumption program.

2. The method of claim 1, wherein said arranging comprises:
transmitting the executable consumption program to the device.

3. The method of claim 2, further comprising:
based on said transmitting, arranging for an exchange of payment with at least one of: (i) a customer, (ii) a provider, and (iii) a third party.

4. The method of claim 3, wherein the exchange of payment is performed via a payment identifier, the payment identifier being further associated with a payment in exchange for the consumable item.

5. The method of claim 2, wherein at least one of said receiving and said transmitting are performed via at least one of: (i) a wireless device, (ii) a Bluetooth device, (iii) a communication port, (iv) a storage device, (v) an optical device, (vi) a magnetic device, and (vii) a device adapted to detect a material.

6. The method of claim 2, wherein said receiving and transmitting are performed by one of: (i) the consumable item, (ii) a device associated with dispensing the consumable item, (iii) a package containing the consumable item, (iv) a medium storing the consumable item, (v) a device attached to the consumable item, (vi) a device incorporated within the consumable item, and (vii) a device located in proximity with the consumable item.

7. The method of claim 1, wherein the request includes at least one of: (i) a requesting device identifier, (ii) a customer identifier, (iii) a consumable item provider identifier, (iv) a third party identifier, (v) a requested executable consumption program identifier, (vi) a current executable consumption program identifier, (vii) a payment identifier, and (viii) a consumable item identifier.

8. The method of claim 1, wherein the consumable item comprises at least one of: (i) fuel, (ii) bandwidth, (iii) entertainment information, (iv) executable information, (v) food, (vi) paper, (vii) electricity, and (viii) information storage capacity.

9. The method of claim 1, wherein the device comprises one of: (i) a device adapted to control a consumption of the consumable item, (ii) a device that consumes the consumable item, (iii) a device powered by the consumable item, (iv) a vehicle, (v) a device adapted to transform the consumable item, (vi) a medium for storing the consumable item, and (vii) a processor for executing or translating the consumable item.

10. The method of claim 1, wherein the executable consumption program is adapted to improve a consumption of the consumable item.

11. The method of claim 1, further comprising:
selecting the executable consumption program based on at least one of: (i) information received from the device, (ii) information associated with the consumable item, and (iii) an ambient condition.

12. The method of claim 1, further comprising:
adjusting the executable consumption program based on at least one of: (i) information received from the device, (ii) information associated with the consumable item, and (iii) an ambient condition.

13. The method of claim 1, further comprising:
dispensing the consumable item.

14. The method of claim 1, further comprising:
verifying that the device is authorized to receive the executable consumption program.

15. An apparatus, comprising:
a processor; and
a storage device in communication with said processor and storing instructions adapted to be executed by said processor to:
receive a request for an executable consumption program, the request being received from a device associated with a consumption of a consumable item; and
transmit the executable consumption program to the device.

16. The apparatus of claim 15, wherein said storage device further stores at least one of: (i) an executable consumption program database, (ii) an executable consumption program rule database, and (iii) a transaction database.

17. The apparatus of claim 15, further comprising:
a communication device coupled to said processor and adapted to communicate with at least one of: (i) a remote information device, (ii) a device adapted to control a consumption of the consumable item, (iii) a device that consumes the consumable item, (iv) a device powered by the consumable item, (v) a vehicle, (vi) a device adapted to transform the consumable item, (vii) a medium for storing the consumable item, (viii) a processor for executing or translating the consumable item, and (ix) a payment device.

18. A medium storing instructions adapted to be executed by a processor to perform a method of facilitating consumption of a consumable item, said method comprising:
receiving a request for an executable consumption program, the request being received from a device associated with a consumption of the consumable item; and
transmitting the executable consumption program to the device.

19. A method of facilitating consumption of a consumable item, comprising:
transmitting an executable consumption program request to a device associated with the consumable item; and
receiving the executable consumption program.

20. The method of claim 19, wherein said transmitting and receiving are performed by one of: (i) a device adapted to control a consumption of the consumable item, (ii) a device that consumes the consumable item, (iii) a device powered by the consumable item, (iv) a vehicle, (v) a device adapted to transform the consumable item, (vi) a medium for storing the consumable item, and (vii) a processor for executing or translating the consumable item.

21. The method of claim 19, wherein the device comprises one of: (i) the consumable item, (ii) a device associated with dispensing the consumable item, (iii) a package containing the consumable item, (iv) a medium storing the consumable item, (v) a device attached to the consumable item, (vi) a device incorporated within the consumable item, and (vii) a device located in proximity with the consumable item.

22. The method of claim 19, further comprising:
executing the executable consumption program.

23. The method of claim 19, further comprising:
consuming the consumable item in accordance with the executable consumption program.

24. A method of facilitating consumption of a consumable item, comprising:
receiving a consumable item along with an executable consumption program;
executing the executable consumption program; and
in response to said execution, receiving a supplemental consumable item.

25. The method of claim 24, wherein at least one of the consumable item and the supplemental consumable item comprises at least one of: (i) text information, (ii) audio information, (iii) image information, (iv) executable information, and (v) entertainment information.

26. The method of claim 24, wherein the consumable item comprises a first set of information and the supplemental consumable item comprises a second set of information associated with the first set.

27. The method of claim 24, wherein the supplemental consumable item comprises supplemental information, and the executable consumption program enables encrypted supplemental information to be retrieved via a communication network.

28. The method of claim 27, wherein the executable consumption program further enables the encrypted supplemental information to be decrypted.

29. The method of claim 24, wherein the consumable item comprises a first type of item and the supplemental consumable item comprises a second type of item.

30. The method of claim 29, wherein the consumable item comprises a storage item and the supplemental consumable item comprises information to be stored via the storage item.

31. A consumable item, comprising:
a consumable portion; and
an executable consumption program portion, the executable consumption program portion comprising a medium storing an executable consumption program, the executable consumption program being associated with the exchange of a supplemental consumable item.
